(19) United States
(12) Patent Application Publication
(10) Pub. No.: US 2005/0277712 A1
(43) Pub. Date: Dec. 15, 2005

(54) Tire sealant

(76) Inventor: Glendon C. Daly, East Lansing, MI (US)

Correspondence Address: Mary M. Moyne;McLEOD & MOYNE, P.C., 2190 Commons Parkway, Okemos, MI, 48864, US

(21) Appl. No.: 11/152,573

(22) Filed: Jun. 14, 2005

Related U.S. Application Data
(60) Provisional application No. 60/579,744, filed on Jun. 15, 2004.
(60) Provisional application No. 60/626,236, filed on Nov. 9, 2004.

(51) Int. Cl. B29C 73/22; B60C 19/12; B60C 17/00; F16F 15/32; G01M 1/32; F16F 15/36; B29C 73/02; B29C 73/16

(52) U.S. Cl. 524/17; 152/503; 156/97; 156/115; 152/154.1; 156/75; 523/166

(57) ABSTRACT

A tire sealant which includes a liquid carrier and a solid particulate and a vehicle wheel which contains the tire sealant. The liquid carrier includes a by-product produced during the processing of an agricultural crop or product.

### CROSS-REFERENCE TO RELATED APPLICATIONS

This application claims the benefit of U.S. Provisional Application Ser. No. 60/579,744, filed Jun. 15, 2004 and U.S. Provisional Application Ser. No. 60/626,236, filed Nov. 9, 2004.

### STATEMENT REGARDING FEDERALLY SPONSORED RESEARCH OR DEVELOPMENT

Not Applicable

### BACKGROUND OF THE INVENTION

(1) Field of the Invention

The present invention relates to a tire sealant having a liquid carrier and a solid particulate. In particular, the present invention relates to a tire sealant where the liquid carrier includes a by-product produced during the processing of an agricultural crop. The present invention also relates to a vehicle wheel including a rim and a pneumatic tire mounted on the rim and having a tire sealant contained in the tire.

(2) Description of the Related Art

The related art has shown various types of sealing compositions for use in tires and tires having compositions for sealing punctures. Illustrative are U.S. Pat. No. 598,613 to Lucas and U.S. Pat. No. 918,189 to McCord et al.

Lucas shows a pneumatic tire, having a coating consisting of a semi-solid viscous substance of permanent fluidity. The substance is molasses or molasses mixed with some other substance such as gum-arabic, gum-tragacinth, liquid glue or mucilage. For large punctures, small solid particles such as saw dust can be mixed with and held in suspension in the substance.

McCord describes a sealing composition for inserting between two layers of the tire. The composition is of an adhesive characteristic and of a semi-liquid or plastic consistency. The composition may be formed of glue, molasses, cotton, tar, vinegar and pung rubber gum.

In addition, a brochure for Sealtite™ Pro manufactured and distributed by Sparty Systems, LLC describes a tire sealant which provides a permanent seal for punctures in tires. The sealant has ceramic fibers which fill the puncture to plug the puncture. As shown by the MSDS sheet for Sealtite™ Pro, the main ingredients of Sealtite™ Pro is ethylene glycol solution and water.

Only of minimal interest is U.S. Pat. No. 5,639,319 to Daly which shows a wheel having a tire and having liquid molasses as a ballast. In one (1) embodiment, the liquid molasses is desugared molasses.

There remains a need for a tire sealant which has a liquid carrier including a by-product produced during the processing of an agricultural crop and solid particulate and which is economical, easily pumped into a tire and environmentally friendly.

### SUMMARY OF THE INVENTION

A tire sealant which contains a liquid carrier and solid particulate and a pneumatic vehicle wheel having the tire sealant. The tire sealant is non-corrosive, non-toxic, non-flammable, non-explosive and biodegradable. The liquid carrier contains carbohydrates and proteins. In one (1) embodiment, the liquid carrier includes a by-product produced during the processing of an agricultural crop or product such as sugar beets, sugar cane, corn, timber or citrus. In one (1) embodiment, the liquid carrier includes desugared molasses, desugared syrup, condensed corn fermented extractives, corn condensed distillers solubles, lignin liquors or a combination thereof. In one (1) embodiment, the desugared molasses is concentrated molasses solids. In one (1) embodiment, the liquid carrier has a solids content between about 10% and 95% by weight which enables the tire sealant to have a viscosity such that the tire sealant can be pumped through small openings such as wheel valves. The tire sealant remains free flowing in liquid form at temperatures between the range of about −35° F. (−37° C.) and about 212° F. (100° C.). In one (1) embodiment, the liquid carrier of the tire sealant optionally includes a gum, an antimicrobial agent or chloride salt, an acid, an anti-corrosion agent, lime, borate or a combination thereof. The gum and alcohol reduce the solids content of the tire sealant to increase the flowability of the tire sealant. The chloride salts and the acids are typically added when the tire sealant has an alkaline pH such as where the main ingredient of the liquid carrier of the tire sealant is desugared molasses. The chloride salts and acids lower the pH and reduce the growth of bacteria and algae in the tire sealant. The lime or borate is added when the tire sealant has an acidic pH such as where the main ingredient of the tire sealant is condensed corn fermented extractives or corn condensed distillers solubles. The lime or borate increases the pH of the tire sealant and reduces the corrosive properties of the tire sealant.

The solid particulate of the tire sealant includes solid particles having a variety of sizes. In one (1) embodiment, the solid particulate is in the form of fibers having different lengths. In one (1) embodiment, the solid particulate is in the form of particles having different sizes and shapes. In one (1) embodiment, the solid particulate is cellulose flock which includes cellulose cotton fibers and rubber particles.

The present invention relates to a tire sealant comprising: a liquid carrier comprising a by-product produced during processing of an agricultural crop; and solid particulate.

Further, the present invention relates to a tire sealant comprising: a liquid carrier selected from the group consisting of sugars, betaine, polymers, proteins, amino acids, starches, gums, carbohydrates, or mixtures thereof; and solid particulate.

Still further, the present invention relates to a tire sealant comprising: a liquid carrier including desugared molasses; and solid particulate.

Further still, the present invention relates to a vehicle wheel having a rim and a pneumatic tire mounted on the rim, wherein the tire contains a tire sealant which comprises a by-product produced during processing of an agricultural product and solid particulate.

Finally, the present invention relates to a method for plugging a puncture in a pneumatic tire mounted on a rim of a wheel which comprises the steps of: filling the tire with a tire sealant having a liquid carrier and solid particulate; filling the tire with pressurized air until the tire has a predetermined air pressure; rotating the wheel to distribute the tire sealant along an inner surface of the tire; allowing the tire sealant to move through the puncture so that the solid particulate of the tire sealant is trapped in the puncture; and continuing to move tire sealant to the puncture until no tire sealant exits the puncture.

The substance and advantages of the present invention will become increasingly apparent by reference to the following drawings and the description.

### BRIEF DESCRIPTION OF THE DRAWINGS

FIG. 1 is a cross-sectional view of a wheel 100 filled to the approximately 11 o'clock position with the tire sealant 10.

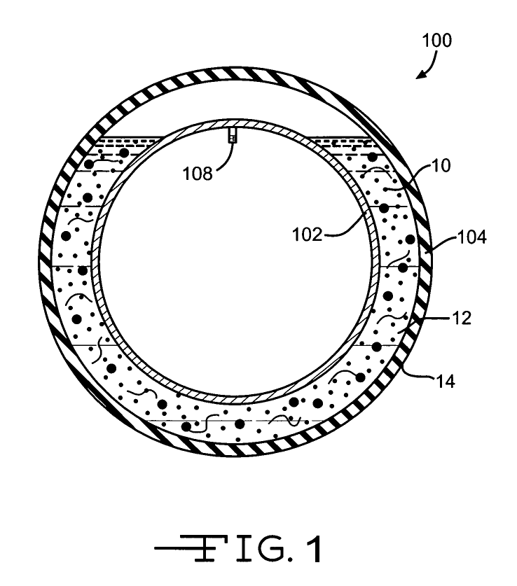

FIG. 2 is a cross-sectional view of a wheel 100 filled to the approximately 7 o'clock position in the tire 104 with the tire sealant 10.

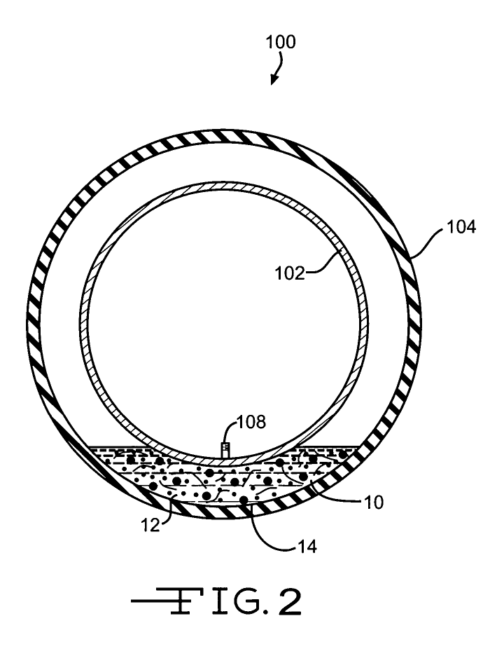

FIG. 3 is a cross-sectional view of a wheel 100 having the tire sealant 10 showing an air leak 106.

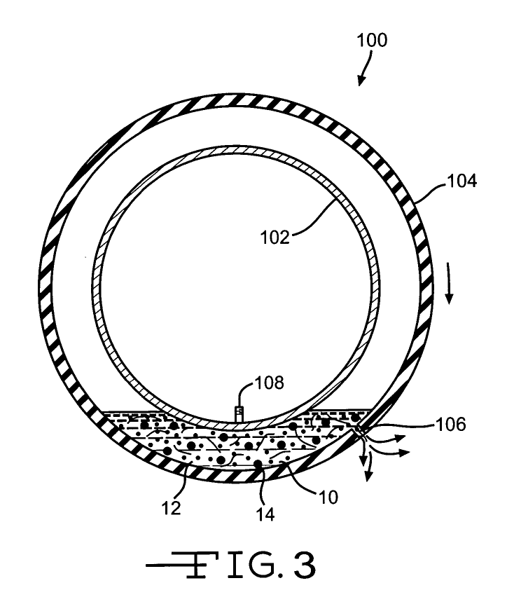

FIG. 4 is a partial cross-sectional view of a wheel 100 having the tire sealant 10 showing the tire sealant 10 moving into the air leak 106 to plug the air leak 106.

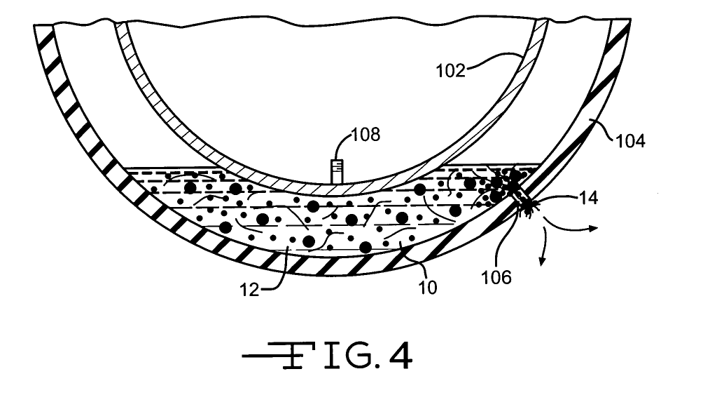

FIG. 5 is a partial, cross-sectional view of a wheel 100 having the tire sealant 10 showing the solid particulate acting to seal the air leak 106.

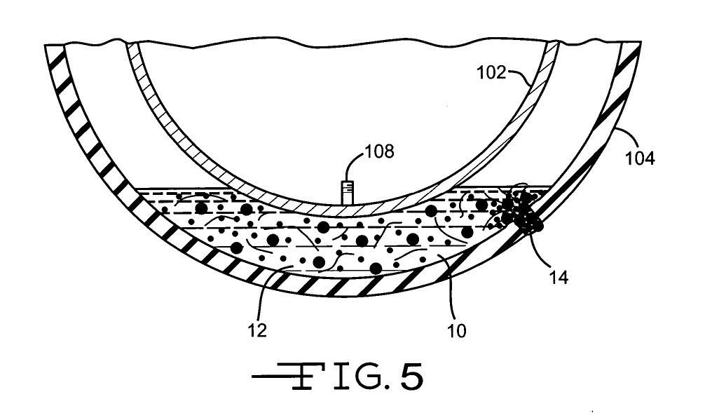

### BRIEF DESCRIPTION OF THE PREFERRED EMBODIMENTS

The tire sealant 10 includes a liquid carrier 12 with a sealant or solid particulate 14. The tire sealant 10 is used in a tire 104 to seal or plug punctures or other air leaks 106 in the tire 104. The tire sealant 10 can also be used for interior balancing of the tire 104. When added to a tire 104 in sufficient amounts, the tire sealant 10 also acts as ballast in the tire 104. The tire sealant 10 is a free flowing fluid or liquid which has a viscosity which enables the tire sealant 10 to be easily pumped into tires 104 through the valve core 108 using standard mechanical pumps. The tire sealant 10 remains in a free flowing fluid form within the appropriate temperature range of −35° F. to 212° F. (−37° C. to 100° C.). The tire sealant 10 is non-corrosive, non-flammable, non-explosive, non-toxic and biodegradable.

The liquid carrier 12 includes carbohydrates and proteins. In one (1) embodiment, the liquid carrier 12 includes a by-product products during the processing of agricultural crops or products. The liquid carrier 12 can include sugars, proteins, amino acids, betaine, polymers, starches, gums or any combination thereof. In one (1) embodiment, the liquid carrier 12 includes desugared molasses, desugared syrup, condensed corn fermented extractives, corn condensed distillers solubles, lignin liquors, citrus extract molasses or any combination thereof. In one (1) embodiment, the liquid carrier 12 also includes alcohol or antifreeze. In one (1) embodiment where the liquid carrier 12 includes lignin liquors, the liquid carrier 12 also includes calcium, ammonium, iron, sodium, copper, manganese and magnesium. In one (1) embodiment, the by-product is derived from the processing of corn, sugar beets, sugar cane, soybeans, sorghum, rice, hemp, timber or citrus. In one (1) embodiment, the liquid carrier 12 is desugared molasses. Desugared molasses is a by-product of the process of removing sugar from sugar beet molasses to make edible sugar. Desugared molasses includes fructose polymers, amino acids, protein polymers, carbohydrates, starches and water. In one (1) embodiment, the liquid carrier 12 is a desugared syrup. In one (1) embodiment, the desugared syrup is the by-product of the removal of sucrose from cane sugar syrup. Desugared syrup is also known as sugar cane molasses. In one (1) embodiment, the liquid carrier 12 is condensed corn fermented extractives which is a by-product of the wet milling process of corn. In one (1) embodiment, the liquid carrier 12 is corn condensed distillers solubles which is a by-product of the dry milling process of corn. It is understood that the ingredients or components and the amount of each ingredient present in the desugared molasses, desugared syrup, condensed corn fermented extractives and the corn condensed distillers solubles depends on the process used to obtain the desugared molasses, condensed corn fermented extractives or corn condensed distillers solubles as well as the origin (growing area) of the original product which is processed. In one (1) embodiment, the liquid carrier 12 is water soluble. In one (1) embodiment, when the tire sealant 10 is dried to a dry mix, such as in an oven or microwave, the tire sealant 10 will become wet and adhere to the tire 104 when the tire sealant 10 is exposed to any moisture (humidity).

The liquid carrier 12 has a Brix value or solids content between about 10% to 95% with the remainder of the liquid carrier 12, about 90% to 5%, being water. The Brix value or solids content of the liquid carrier 12 enables the liquid carrier 12 to hold the solid particulate 14 in suspension in the liquid carrier 12. The components of the liquid carrier 12 are dense and the solid particulate 14 attach to the liquid carrier 12 to remain in suspension. Being held in suspension, the solid particulate 14 does not settle to the bottom or side of the tire 104, congeal, or form a lump or pile. Staying in suspension allows full use of the solid particulate 14 for filling or plugging holes, punctures or leaks 106 in the tire 104.

In one (1) embodiment, the liquid carrier 12 contains approximately 0.005% to 12% betaine. Increasing the betaine content of the liquid carrier 12 to approximately 80% to 85% causes the liquid carrier 12 to create foam during agitation. Rotation of the wheel 100 agitates the liquid carrier 12 and causes the betaine in the liquid carrier 12 to foam. The foaming action from the betaine causes the solid particulate 14 to rise within the tire 104 providing better coverage by the tire sealant 10. The foam helps to coat the inner side of the tire 104 and the rim 102 with free floating solid particulate 14. The dense bubbles of the foam hold the solid particulate 14 and enable the solid particulate 14 to rise to the top of the tire 104. The use of additional betaine allows the solid particulate 14 to be in the top of the tire 104 and the rim 102, as well as in the bottom of the tire 104 without the need to fill the tire essentially completely with the tire sealant 10. In one (1) embodiment, the amount of betaine is chosen so that upon agitation, foam fully fills the tire 104.

The composition of the liquid carrier 12 of the tire sealant 10 enables the tire sealant 10 to be operational to temperatures of approximately −35° F. below zero (−37° C.). In one (1) embodiment, the first ice crystals do not form in the tire sealant 10 until the temperature of the liquid carrier 12 is greater than −26° F. below zero (−32° C.). In one (1) embodiment, sodium chloride, magnesium chloride, calcium chloride or potassium chloride salts are added to the liquid carrier 12 to act as an antifreeze.

The solid particulate 14 can be in the form of fibers, granules, strips, crystals, plastic string lines, threads, beads, pellets, particles, powders or mixtures thereof. The tire sealant 10 can include ceramic, ceramic particles, ceramic fibers, cellulose, cellulose fibers, cotton fibers, ground rubber, latex, graphite, nylon, aramid fibers, wood, resin formulations, rubber emulsion, vinyl copolymers, acrylic or acrylate esters, and various polymers or combinations thereof. In one (1) embodiment, the solid particulate 14 is cellulose flock which includes a cotton fiber base and rubber particles. The cotton fiber base includes cellulose cotton fibers which are long and stringy similar to blown in insulation. The cellulose cotton fibers adhere to the puncture or hole 106 in the tire 104 and the rubber particles blend within the liquid carrier 12 and plug the leak 106. When the cellulose flock is injected into the liquid carrier 12, the cellulose cotton fibers absorb water and expand and fill the tire 104. In one (1) embodiment, the tire sealant 10 contains approximately 6% to 12% of cellulose flock as the solid particulate.

Other products such as a tire balancer, similar to Equal™ manufactured by International Marketing, Inc., may be added to the tire sealant 10 so that the tire sealant 10 will also act as a tire balancing agent. The tire balancer includes granular polymers. The tire sealant 10 helps to keep the granular polymers of the tire balancer in place within the tire 104. The granular polymers are held in suspension in the liquid carrier 12 which allows the tire sealant 10 with the tire balancer to act as a tire balancing agent. The tire sealant 10 holds the granular polymers of the tire balancer tightly to the center of the tire 104 adjacent the rim 102 providing better balance, less vibration, a smoother ride, longer tire life and more uniform tread wear.

The tire sealant 10 when used in sufficient amounts, acts as a tire ballast. Due to the liquid carrier 12 of the tire sealant 10, the weight of the tire sealant 10 in the wheel 100 is adjacent the bottom of the wheel 100 and to the sides of the axle. This keeps weight off of the axle which can extend the life of the transmission, rear end gears, and axle bearings. Use of the tire sealant 10 as a ballast provides added weight to the wheel 100 which helps to stabilize equipment or vehicles which tend to rollover, such as off-road vehicles (ATVs), tractors and other equipment. The extra weight puts more weight at a lower center of gravity to help stabilize the vehicle helping to reduce rollovers. The tire 104 is filled to at least about the 10 o'clock position of the wheel 100 with the tire sealant 10 to allow the tire sealant 10 to act as a sealant and a ballast. In this embodiment, less betaine or no betaine is added to the tire sealant 10 so that minimal or no foam is formed during rotation of the wheel 100. In one (1) embodiment where the liquid carrier 12 includes desugared molasses, the weight of the desugared molasses is approximately 10.7 lbs/gallon.

The tire sealant 10 also acts as an anti-corrosive agent on the rim 102 inside the tire 104. The liquid carrier 12 is hydroscopic and absorbs the water. Therefore, the liquid carrier 12 reduces the oxidation of water to the metal of the rim 102. The liquid carrier 12 adheres to the water molecules, preventing the corrosion of the rim 102 of the wheel 100. The liquid carrier 12 leaves a polymerized coating on the rim 102 to aid in controlling corrosion. In addition, rust inhibitors may be added to the liquid carrier 12 of the tire sealant 10 to provide additional protection against rust on iron and steel surfaces. Adding borate to the liquid carrier 12 will give the tire sealant 10 a pH between about 7.0 and 14. Silicate or nitrate can be added to the liquid carrier 12 to provide added rust protection for aluminum and ferrous metals.

Acids can be added to the tire sealant 10 to lower the pH to 7.0±2% to control bacterial growth in the tire sealant 10. Lowering the pH level to neutral (7.0) slows the bacteria action level and reduces odor. Some of the acids which can be added are phosphoric acid, acetic acid, sulfuric acid, hydrochloric acid, propionic acid or any combination thereof. In one (1) embodiment, the percentage of acid in the tire sealant 10 ranges from approximately 0.25% to approximately 10%. An anti-bactericide can also be added to reduce or eliminate bacteria and odor. Any well known anti-bactericide can be added to eliminate or reduce bacteria action and degradation in the tire sealant 10. Amine or ester oils, such as those manufactured by Feed Flavors Inc. can also be used to reduce odor.

In use, the tire sealant 10 is placed in the tire 104 of the wheel 100 before an air leak or puncture 106 occurs. In one (1) embodiment, the solid particulate 14 is mixed with the liquid carrier 12 prior to injection into the tire 104. In one (1) embodiment, the solid particulate 14 is dumped, poured or pumped into the liquid carrier 12 and mixed until the solid particulate 14 is evenly distributed throughout the liquid carrier 12. In another embodiment, the liquid carrier 12 and solid particulate 14 are injected separately into the tire 104 and mixed in the tire 104 as a result of the rotation of the wheel 100. In one (1) embodiment, the liquid carrier 12 is heated prior to injection into the tire 104 for added stability. To inject the tire sealant 10 into the tire 104, the valve stem of the wheel 100 must be removed from the valve core 108, and the air released from the tire 104. Next, the tire sealant 10 is pumped into the tire 104 through the valve core 108. The mix ratios of the tire sealant 10 varies from 0.5% to approximately 95% of solid particulate 14 to liquid carrier 12. For tire sealants 10 having less than approximately 60% solid particulate 14, a standard, mechanical pump can be used to move the tire sealant 10 into the tire 104. For tire sealants 10 having greater than approximately 60% solid particulate 14, special gear pumps may be needed to inject the tire sealant 10 into the tire 104. In one (1) embodiment where the liquid carrier 12 is desugared molasses, the viscosity of the liquid carrier 12 enables the tire sealant 10 to be inserted into the tire 104 using a standard mechanical pump or an air compressor. In one (1) embodiment, the tire sealant 10 is in a container and the container is pressurized such as with air, CO₂, nitrogen, helium and/or any other gas so that the tire sealant 10 is forced directly into the tire 104.

When the pumping of the tire sealant 10 is complete and the correct amount of tire sealant 10 is deposited into the tire 104, the valve stem is placed back into the valve core 108, and the tire 104 is reinflated to the recommended air pressure. The tire 104 is filled with the tire sealant 10 only at the bottom of the tire 104 or to about the 5 o'clock position of the wheel 100 to enable the tire sealant 10 to act as a sealant and plug air leaks. Only a portion of the tire 104 is filled. In one (1) embodiment where the tire sealant 10 is acting as a ballast and a sealant, the tire 104 is filled to at least about the 10 o'clock position of the wheel 100. Prior to full use of the wheel 100, the wheel 100 is rotated several times to ensure complete coverage of the inner surface of the tire 104 and the rim 102 by the tire sealant 10. As the wheel 100 rotates, the tire sealant 10 is deposited on the inner surface of the tire 104. In one (1) embodiment, the viscosity of the tire sealant 10 enables easy movement of the tire sealant 10 within the tire 104 over a wide range of temperatures so that the solid particulate 14 is easily moved to all areas of the tire 104, after only one (1) revolution of the wheel 100. As the wheel 100 rotates, the tire sealant 10 moves around the inside of the tire 104 and the tire sealant 10 is agitated. In one (1) embodiment, foam is produced as a result of the agitation of the tire sealant 10. In this embodiment, the solid particulate 14 is carried around the inside of the tire 104 by the foam.

When a puncture or leak 106 occurs, the pressure of the air within the tire 104, centrifugal force of the rotating wheel 100, and the weight of the vehicle, all compress the tire 104, forcing the liquid carrier 12 with the solid particulate 14 out of the puncture 106. The puncture or leak 106 is not plugged by the tire sealant 10 until the wheel 100 rotates so that the puncture or leak 106 is within the area having the tire sealant 10. The fibers or particles of the solid particulate 14 having a longer length or larger size enter the puncture 106 first. In one (1) embodiment, the long fibers have a length of between about 0.0788 to 0.788 inches (2 to 20 mm). Next, the smaller particles or fibers lock onto and into the spaces left open by the larger particles or fibers. The liquid carrier 12 helps to hold the solid particulate 14 in place in the puncture 106. Finally, the pressure of the air inside the tire 104, centrifugal force of the wheel 100 and the weight of the vehicle force the water out of the liquid carrier 12 in the puncture 106, leaving a dry, tight plug in the former puncture. When the solid particulate 14 totally fills the puncture 106, the air stops flowing through the puncture 106, and the puncture 106 is sealed. Once the solid particulate 14 of the tire sealant 10 seal or plug a puncture 106, the tire sealant 10 is no longer water soluble and will not deteriorate in standing water. The liquid carrier 12 helps the tire sealant 10 protect the sealed leak by reducing friction between the tire 104 and the solid particulate 14 forming the plug in the former leak.

The tire sealant 10 is also reusable. The tire sealant 10 can be pumped out of the tire 104 through the valve core 108 of the wheel 100. For most efficient removal, the valve is positioned at about the 6 o'clock position of the wheel 100. Once the tire sealant 10 is removed from the tire 104, the wheel 100 or tire 104 is removed and replaced. The removed tire sealant 10 is then pumped into the new tire 104.

### EXAMPLE 1

In the first example, one (1) front wheel 100 of a farm wagon was injected with tire sealant 10. The liquid carrier 12 included desugared molasses similar to the desugared molasses produced as a by-product of processing sugar beets by Michigan Sugar Company. The solid particulate 14 was cellulose fibers having various shapes including long and slender, long and fat, round, oblong, smooth or jagged. The fibers of the solid particulate 14 had a length of between about 0.03125 and 2.5 inches (0.79 and 63.5 mm). The tire 104 had an initial inner volume of 12,500 ml (12.5 L). The tire 104 was injected with 24 pints (11,520 ml) of the liquid carrier 12 and 2.4 pints (1,152 ml) of solid particulate 14. To fill the tire 104 with the tire sealant 10, the wheel 100 was lifted off the ground and the wheel 100 rotated so the valve was at the 5 o'clock position of the wheel 100. The liquid carrier 12 and sealant 10 were then inserted or pumped separately into the tire 104 through the valve. Once all the tire sealant 10 was in the tire 104, 34 lbs. of air pressure was added to the tire 104. The tire 104 was then rotated to mix the liquid carrier 12 and the solid particulate 14 and to distribute the tire sealant 10 along the inner surface of the tire 104. To create the air leak 104, a hammer with a 6 inch (152 mm) spike nail welded to the head was smashed into the tire 104. The nail punctured the tire 104, causing the tire 104 to lose air pressure. The wheel 100 was then continually rotated allowing the solid particulate 14 to be carried to the puncture 106 by the liquid carrier 12. The air pressure in the tire 104 forced the tire sealant 10 out the puncture 106. As the tire sealant 10 was forced out through the puncture 106, the solid particulate 14 was trapped or caught in the puncture 106. Once the air pressure could no longer force any additional tire sealant 10 out the puncture 106, the puncture 106 was sealed, stopping all air leaks. The tire 100 was then refilled to 34 lbs. of air pressure. The tire sealant 10 plugged the puncture 106 and stopped the air leak within about 5 revolutions of the wheel 100. The various particles or fibers of the solid particulate 14 plugged the puncture 106 quickly due to the various shapes of the particles or fibers. The tire 104 was lowered into a container having approximately 15 gallons (56,850 ml) of water so that the tire 104 was partially submerged in the water with the puncture 106 completely submerged in water and the tire 100 was resting on the ground surface and supporting the wagon. Initially, there were no bubbles in the water from the puncture 106 to indicate loss of air. The tire 104 was left in the water for four (4) days. After four (4) days, no bubbles and no leaks were noticed. The air pressure of the tire 104 remained at 34 lbs.

### EXAMPLE 2

In a second example, a front wheel 100 of a wagon was filled to the 12 o'clock position of the wheel 100 with the tire sealant 10. The tire sealant 10 was the same as used in Example 1. The tire 104 was filled with 150 pints (72,000 ml) of the liquid carrier 12 and 15 pints (7200 ml) of the solid particulate 14. The liquid carrier 12 and solid particulate 14 were added to the tire 104 similarly to the first example. The amount of tire sealant 10 added to the tire 104 was to enable the tire sealant 10 to act as a ballast as well as a sealant. The tire 104 was punctured as in Example 1. The tire 104 was also placed in water for four (4) days and no leaks were present after four (4) days.

It is intended that the foregoing description be only illustrative of the present invention and that the present invention be limited only by the hereinafter appended claims.

1. A tire sealant comprising:
(a) a liquid carrier comprising a by-product produced during processing of an agricultural crop; and
(b) solid particulate.

2. The tire sealant of claim 1 wherein the agricultural crop is selected from the group consisting of corn, sugar beets, sugar cane, timber, citrus and mixtures thereof.

3. The tire sealant of claim 1 wherein the by-product is desugared molasses.

4. The tire sealant of claim 1 wherein the by-product is desugared syrup.

5. The tire sealant of claim 1 wherein the by-product is corn condensed distillers solubles.

6. The tire sealant of claim 1 wherein the by-product is condensed corn fermented extractives.

7. The tire sealant of claim 1 wherein the solid particulate is selected from the group consisting of cellulose, plastic string, cellulose fiber, ground rubber, latex, ceramic, polymers, graphite, nylon, aramid fibers, and mixtures thereof.

8. The tire sealant of claim 1 wherein the solid particulate are selected from the group consisting of fibers, granules, powders, pellets, crystals, particles and mixtures thereof.

9. The tire sealant of claim 1 wherein the solid particulate is cellulose flock.

10. The tire sealant of claim 1 wherein betaine is added to the liquid carrier to create foam.

11. The tire sealant of claim 10 wherein between about 80% to 85% of the liquid carrier is betaine.

12. The tire sealant of claim 1 wherein the liquid carrier remains free flowing in liquid form at temperatures between about −35° F. to about 212° F. (−37° C. to 100° C.).

13. The tire sealant of claim 1 wherein the liquid carrier has a viscosity such that the tire sealant is pumped into a tire using a mechanical pump.

14. A tire sealant comprising:
(a) a liquid carrier selected from the group consisting of sugars, betaine, polymers, proteins, amino acids, starches, gums, carbohydrates, or mixtures thereof; and
(b) solid particulate.

15. The tire sealant of claim 14 wherein the liquid carrier includes desugared molasses.

16. The tire sealant of claim 14 wherein the liquid carrier includes desugared syrup.

17. The tire sealant of claim 14 wherein the liquid carrier includes condensed corn fermented extractives.

18. The tire sealant of claim 14 wherein the liquid carrier includes corn condensed distillers solubles.

19. The tire sealant of claim 14 wherein the solid particulate are selected from the group consisting of fibers, granules, powders, pellets, crystals, particles and mixtures thereof.

20. The tire sealant of claim 14 wherein the solid particulate is cellulose flock.

21. The tire sealant of claim 14 wherein the solid particulate is selected from the group consisting of cellulose, plastic string, cellulose fiber, ground rubber, latex, ceramic, polymers, graphite, nylon, aramid fibers, and mixtures thereof.

22. The tire sealant of claim 14 wherein the liquid carrier is selected from the group consisting of desugared molasses, desugared syrup, corn condensed distillers solubles, condensed corn fermented extractives, lignin liquors and mixtures thereof.

23. The tire sealant of claim 14 wherein betaine is added to the liquid carrier to create foam.

24. The tire sealant of claim 14 wherein the liquid carrier remains free flowing in liquid form at temperatures between the range of about −35° F. to about 212° F. (−37° C. to 100° C.)

25. A tire sealant comprising:
(a) a liquid carrier including desugared molasses; and
(b) solid particulate.

26. The tire sealant of claim 25 wherein the solid particulate selected from the group consisting of are fibers, granules, powders, pellets, crystals, particles and mixtures thereof.

27. The tire sealant of claim 25 wherein the solid particulate is selected from the group consisting of cellulose, plastic string, cellulose fiber, ground rubber, latex, ceramic, polymers, graphite, nylon, aramid fibers, and mixtures thereof.

28. The tire sealant of claim 25 wherein the solid particulate is cellulose flock.

29. The tire sealant of claim 25 wherein betaine is added to the liquid carrier to create foam.

30. The tire sealant of claim 25 wherein the liquid carrier remains freely flowing in liquid form at temperatures between the range of about −35° F. to about 212° F. (−37° C. to 100° C.).

31. A vehicle wheel having a rim and a pneumatic tire mounted on the rim, wherein the tire contains a tire sealant which comprises a by-product produced during processing of an agricultural product and solid particulate.

32. The vehicle wheel of claim 31 wherein the by-product is desugared molasses.

33. The vehicle wheel of claim 31 wherein the by-product is selected from the group consisting of desugared molasses, desugared syrup, corn condensed distillers solubles, condensed corn fermented extractives, lignin liquors, citrus extract molasses and mixtures thereof.

34. A method for plugging a puncture in a pneumatic tire mounted on a rim of a wheel which comprises the steps of:
(a) filling the tire with a tire sealant having a liquid carrier and solid particulate;
(b) filling the tire with pressurized air until the tire has a predetermined air pressure;
(c) rotating the wheel to distribute the tire sealant along an inner surface of the tire;
(d) allowing the tire sealant to move through the puncture so that the solid particulate of the tire sealant is trapped in the puncture; and
(e) continuing to move tire sealant to the puncture until no tire sealant exits the puncture.

35. The method of claim 34 wherein steps (a), (b) and (c) are completed before the tire is punctured.

36. The method of claim 34 wherein the liquid carrier is desugared molasses which remains free flowing in liquid form at temperatures between the range of approximately −35° F. to approximately 212° F. (−37° C. to 100° C.).

37. The method of claim 34 wherein in step (e), when the tire sealant exits through the puncture, water is removed to form a solid plug in the puncture.

38. The method of claim 37 wherein the solid plug is formed by the solid particulate.

39. The method of claim 34 wherein in steps (d) and (e), the tire sealant is moved through the puncture by the pressurized air in the tire.

40. The method of claim 34 wherein the solid particulate is comprised of fibers having various sizes and length and wherein in step (d), longer fibers are trapped in the puncture first and then smaller fibers fill in any remaining spaces in the puncture to completely plug the puncture.

41. The method of claim 34 wherein in step (a), the tire is filled with the tire sealant using a mechanical pump to move the tire sealant into the tire through a valve core of the wheel.

42. The method of claim 34 wherein in step (a), the tire is filled until the tire sealant reaches a 7 o'clock position of the wheel.

43. The method of claim 34 wherein in step (a), the tire is filled until the tire sealant reaches at least a 10 o'clock position of the wheel and the tire sealant acts as a tire ballast for the wheel.

44. The method of claim 34 wherein the liquid carrier includes about 0.005% to about 12% betaine, wherein in step (c), as the wheel rotates, the tire sealant is agitated which causes the betaine to create foam and wherein the foam moves the solid particulate to a top of the tire.

45. The method of claim 34 wherein the tire sealant includes a tire balance, wherein the tire balance is in suspension in the liquid carrier and wherein in step (c), when the wheel rotates the tire sealant balances the wheel and reduces vibration.
